(19) United States
(12) Patent Application Publication
(10) Pub. No.: US 2008/0256843 A1
(43) Pub. Date: Oct. 23, 2008

(54) Insect Bait Station

(75) Inventors: Richard Hack, Indianapolis, IN (US); Stuart Allen Volby, Hackensack, MN (US)

Correspondence Address: SHOOK, HARDY & BACON LLP;INTELLECTUAL PROPERTY DEPARTMENT, 2555 GRAND BLVD, KANSAS CITY, MO, 64108-2613, US

(73) Assignee: BAYER HEALTHCARE LLC, TARRYTOWN, NY (US)

(21) Appl. No.: 11/577,145

(22) PCT Filed: Oct. 12, 2005
(86) PCT No.: PCT/US2005/036525

§ 371 Date: Apr. 12, 2007

Related U.S. Application Data
(60) Provisional application No. 60/618,047, filed on Oct. 12, 2004.

(51) Int. Cl. A01M 1/20

(52) U.S. Cl. 43/131; 29/428

(57) ABSTRACT

A device for controlling insects, especially flying insects. The device has two screens joined by a series of seams to form pockets. Pellets containing attractants and poison are placed in the pockets and insects come to feed on the poison. The screen openings are large enough to permit the insects to feed on the pellets, but not so large that the pellets fall out of the pockets.

This application claims benefit of U.S. Provisional Application Ser. No. 60/618,047; filed on Oct. 12, 2004, the contents of which are incorporated herein by reference in their entirety.

### FIELD OF THE INVENTION

This invention relates to insect control in animal living and confinement facilities, veterinary kennels and commercial facilities such as restaurants, warehouses, and large-scale animal facilities. The invention also relates to methods and devices useful in such control.

### BACKGROUND OF THE INVENTION

Flies and other flying insect pests seem to appear wherever they are not wanted. Flying insects can spread disease and are annoying. Animals, including domesticated animals and livestock, can be adversely affected by flying insects, reducing production of food and other important resources.

People have been trying to eliminate these pests since the dawn of recorded history. Among the approaches that have been tried include repelling the pests, providing a barrier against them, and killing them. No approach has worked perfectly, and people have been working on building better traps to catch and kill these pests almost as long as civilization has endured.

Early attempts at killing flying insects were simply manual fly swatters that people used to kill flies and whisks that were used to keep the insects from landing in undesirable locations. Aside from requiring a human swatter, these methods proved insufficient because they only worked on one insect at a time or because the insects would still land on food and in other undesired locations before being shooed away.

Fly paper and strips were an improvement, because they did not require human intervention while working. This sticky paper snared and held insects in place until they died. After a time the paper or strips could be replaced and the strip with dead insects could be discarded. Fly paper, however, failed fairly easily. The adhesive did not always work well, and the dead insects quickly repelled living insects.

More recent traps have proven more successful. They often capitalize on sophisticated chemicals such as pheromones and bait to lure flying insects. Modern traps may also rely on instinctive behaviors to trap the insects.

U.S. Pat. No. 5,987,810 to Nash issued Nov. 23, 1999, discloses an insect trap made up of a horizontal circular screen mounted on a cylindrical bowl. The screen is coated with an insecticide. Underneath the screen is an attractant container that emits the attractant. The insects are attracted to the screens, are killed, and fall through the screens to the bottom of the bowl.

U.S. Pat. No. 6,219,960 to Contadini et al. issued Apr. 24, 2001, discloses a bait station containing a membrane overlying insect poison. Insects enter the bait station, cross the membrane, and are poisoned. The insects leave the bait station and then die.

U.S. Pat. No. 5,869,697 to Kang issued Apr. 27, 1999, is directed to a mosquito trap having a mesh lying on top of a water bath. A female mosquito lays eggs in the surface of the water bath, and the mesh prevents the offspring from escaping.

U.S. Pat. No. 5,311,697 to Cavanaugh et al., issued May 17, 1994, is directed to a flying insect device having a plurality of storage shelves for holding insect bait. A reservoir contains a defatting agent that circulates through the device in a waterfall manner. The flying insects are attracted by the bait and are killed by contact with the defatting agent. The defatting agent flows through a screen that separates the dead insects from the defatting agent, which is then recirculated.

U.S. Pat. No. 4,069,615 to Gilbert issued Jan. 24, 1978, discloses a flying insect deterring screen comprising a plurality of flexible strips mounted on a motor that transmits motions to the strips that prevent passage of insects through the screen.

U.S. Pat. No. 6,546,667 to Carter, issued Apr. 15, 2003, discloses a fly trap with a cylindrical mesh side wall and a conical entrance underneath the trap. The trap is slightly raised on a stand, and flies enter the trap through the conical entrance. The flies are attracted to the trap using an attractant and they enter the trap through the conical entrance. The flies are then confused by the screen enclosure and cannot find their way back to the narrow end of the conical entrance.

Another trap using a conical opening is described in Dowd, P., et al., “Novel Insect Trap Useful in Capturing Sap Beetles (Coleoptera: Nitidulidae) and Other Flying Insects,” J. of Economic Entomology, 85(3), pp. 772-78 (1992). This freestanding trap attracts flying insects by using a conical entrance.

U.S. Pat. No. 4,501,088 to Boisvert et al., issued Feb. 26, 1985, is directed to a multiple chamber fly trap. The flies enter a circular chamber through a plurality of entrances into an interior region with a bait dish. The exits from the interior region are conical and lead to a screened annular space around the circular chamber. The flies enter this annular region and cannot find their way out through the narrow end of the conical exits.

U.S. Patent App. Pub. No. 2003/0014904 to Chrestrnan published Jan. 23, 2003, and U.S. Pat. No. 6,505,435 to Chrestman, issued Jan. 14, 2003, are each directed to a yellow jacket and fly trap with a conical entrance. A bait receptacle is placed within the conical entrance. The flies or yellow jackets leave the bait receptacle and fly upward through the entrance into the mesh trap. They are unable to find their way out again through the small conical entrance.

U.S. Pat. No. 6,360,477 to Flashinsid et al., issued Mar. 26, 2002, discloses an article to dispense a volatile insecticide. The article is folded and, when opened, acts as a substrate for the insecticide as it diffuses.

U.S. Pat. No. 6,183,733 to McKibben, issued Feb. 6, 2001, is directed to a combination of a pheromone and a series of plant extracts from the plants found in overwintering sites for boll weevils. The combination is an especially powerful attractant for boll weevils.

European Patent No. 294,175 to Cook published Feb. 26, 1992, is directed to a carrier for an insect pheromone. The carrier is a cylindrical tube that is put into a holder in an insect trap to bring insects to the trap.

A survey of various insect traps may be found in Pinniger, D., “Food-Baited Traps; Past, Present and Future,” J. of the Kansas Entomological Soc. 63(4), pp. 533-38 (1990).

Products are on the market that are referred to as “no-pest” strips. These products are used in households and contain a resinous strip impregnated with an insecticide. These strips are housed in cardboard packages with large holes to permit the insecticide to diffuse through the room.

Another product on the market that contains an insecticide and an attractant is known as a “QuikStrike” Fly Abatement Strip. This product comes in a perforated housing and is designed to be placed no more than about three feet above the ground. An ampule of attractant is opened over the trap and attracts feeding flies. The flies are quickly poisoned by walking over the exposed poison and eating poisoned bait.

Despite the progress of the prior art, a need remains for a convenient, long-lasting insect control system that requires the absolute minimum of human intervention combined with high effectiveness.

### SUMMARY OF THE INVENTION

The principal object of the invention therefore is to provide a device controlling insects, especially flying insects, in animal living and confinement facilities, veterinary kennels and commercial facilities such as restaurants, warehouses, and large-scale animal facilities.

Another object of the invention is to provide a method for controlling insects, especially flying insects, in large facilities using the device of the invention.

An additional object of the invention is to provide a method for manufacturing the device of the invention.

Additional objects and advantages of the invention will be set forth in part in the description that follows, and in part will be obvious from this description, or may be learned by practice of the invention. The objects and advantages of the invention may be realized and attained by means of the instrumentalities and combinations particularly pointed out in the appended claims.

To achieve the foregoing objects and in accordance with the purpose of the invention, as embodied and broadly described herein, the invention provides a device for attracting and killing insects comprising a first screen and a second screen comprising a plurality of openings. The first screen and the second screen are attached through a plurality of seams to form a plurality of pockets between the two screens. A plurality of pellets is positioned in the pockets. These pellets comprise both an attractant and a poison for insects. The openings in the screens are sufficiently large to permit insects to feed on the pellets, but not so large that the pellets fall out of the device through the holes.

To achieve the foregoing objects and in accordance with the purpose of the invention, as embodied and broadly described herein, the invention further provides a method for controlling insects, especially flying insects, by hanging or otherwise supporting the device of the invention at least about four feet above ground level.

An advantage of the invention is that the device does not lose effectiveness as more and more insects are killed because the insects fall off the device and do not block access to the poison in the openings.

An additional advantage of the invention is that the bait and attractant may be located at least about four feet above ground level so they do not compete with other attractants at ground level that may overpower the effect of the bait or attractant.

An additional advantage of the invention is that the device may work for a long time with no human intervention. The device does not require extensive installation activities, nor does it require electricity to be effective.

### BRIEF DESCRIPTION OF THE DRAWINGS

FIG. 1 is a three quarter view of the device of the invention, showing the pellets that are present in the pockets as a cutaway.

FIG. 2 is an outline of the method of manufacturing the device, but it does not show final packaging or addition of the housing, which may be done using well-known techniques.

### DETAILED DESCRIPTION OF THE INVENTION

Reference will now be made in detail to the presently preferred embodiments of the invention.

This invention relates to a unique segmented strip that holds granular pellets that release insect attractants, such as pheromones, that attract pests to the strip. The pellets also comprise an insecticide. When the pest touches or feeds on the pellets it is killed.

The invention is further illustrated by the following examples. Those skilled in the art will recognize that the invention is not bound or limited to these examples.

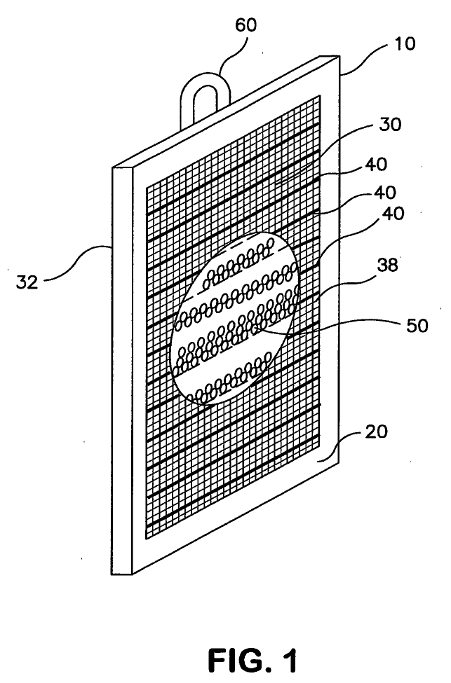

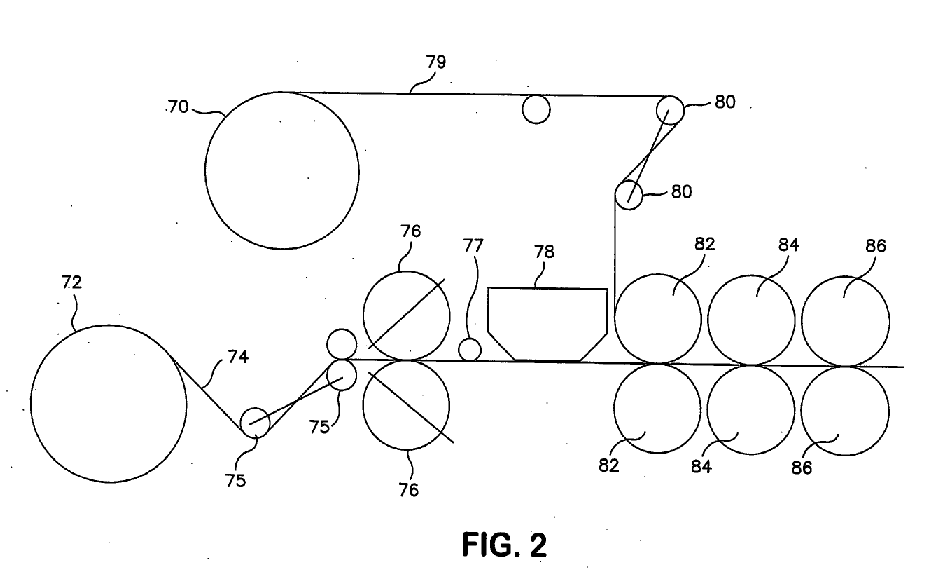

The invention is illustrated in FIGS. 1 and 2. As shown, the device is generally rectangular and is oriented with the long sides of the rectangle oriented vertically. Both the shape and orientation of the device are arbitrary, although the alignment as shown is a preferred embodiment of the invention. The device may be any shape and any orientation, although certain advantages of the preferred embodiment may not be available with alternative configurations. For example, the preferred design and orientation allows gravity to assist in providing a favorable distribution of pellets within the device. The vertical orientation allows access to the pellets from both sides of the device and provides flow-through ventilation that assists in transport of any attractant that may be used in the device. As used herein, the terms vertical and horizontal will refer to the preferred embodiment set forth in FIG. 1. Those skilled in the art will recognize that other configurations and designs are possible and that the invention as described herein may easily be modified for such other configurations and designs.

The device comprises a housing 10 that may be made of cardboard, Kraft paper, plastic or any other material useful for the purpose. While the color of the housing material is not important to the invention, a preferred color is yellow or red, because these colors tend to attract flies. The size of the housing is not material to the invention and may be made larger or smaller depending on the desired use of the device. A larger device may be preferable for situations in which less frequent replacement of the device is desirable, and smaller devices may be preferable for areas or household use. In one embodiment of the invention, the housing is from about 2 inches to about 12 inches wide, more preferable about 4 inches to about 8 inches wide, and most preferably about 4.5 inches wide. In such an embodiment, the housing would be from about 6 inches to about 36 inches in length, more preferably about 10 inches to about 24 inches in length, and most preferably about 12 inches in length.

The housing holds two screens 30, 32. These screens may be set any convenient distance apart, but the screens should be far enough apart to provide for easy manufacturing and for an ample supply of bait pellets, yet close enough together to provide for easy formation of pockets, as described more fully below, and to allow for an economic amount of bait pellets to be used. In one embodiment of the invention, the two screens are less than about 0.5 inches apart more preferably less than about 0.25 inches apart and most preferably less than about 0.125 inches apart. As with the housing, the color of the screens is not essential to the invention, but yellow and red are preferred colors, with red being the most preferred. The screens may be manufactured from any convenient material. Plastics and polymeric materials are preferred. The most preferred material is polypropylene.

The screens comprise a mesh having a plurality of openings 20. These openings are sufficiently narrow to hold the pellets within pockets 38 (described more fully below). The openings are not, however, so small that pests do not have access to the pellets. In the preferred embodiment of the invention, these openings have a mesh size of about 0.018 inches. No particular shape for the openings is preferred for the mode of action of the invention, but square or rectangular openings that form a mesh are preferred for ease of manufacture. The size of the openings may also be defined using art-recognized sieve or mesh sizes for the convenience of commercial manufacturing.

A plurality of horizontal seams 40, formed by joining the two screens, forms the tops and bottoms of pockets 38. This joining may be accomplished by a series of ledges formed in one or the other screen or more easily by sealing the screens together at various points during manufacture, as described more fully below.

The device also comprises a series of pellets 50 held in the pockets. These pellets should be large enough so that they do not fall through the mesh of the screens yet small enough so that they can move freely within the pockets. The size allows the pellets to spread out along the pocket to provide a large effective surface area for the device. The pellets should preferably comprise both an attractant and a poison, although an alternative embodiment may have separate attractant pellets and poison pellets.

The device may further comprise a device, such as tab 60 for hanging from an elevated location or, in an alternative embodiment, a stand or support (not shown) to place the device on a flat surface, such as a table. Alternative embodiments are possible, although the preferred configuration is to hang the device from a nail or hook located at least about four feet above ground or floor level. This height keeps the device away from livestock and lets the device work during the day and during the night Flies and other insects often drop to lower heights during part of the day and retreat to higher levels at other times.

Acceptable insecticides include any known insecticide that can be manufactured or incorporated into pellet form, either because they are themselves solids or because they are capable of being incorporated into or on the surface of substrates through spray coating or other techniques known in the art. Without limitation, acceptable insecticides include organophosphates, carbamates, chloro-nicotinyls, pyrethrins, and pyrethroids.

Acceptable attractants include, without limitation, food based attractants and pheromones such as Z-9 Triclosene.

The invention may be manufactured using conventional techniques well known in the art of manufacturing plastic items. A preferred technique is shown in FIG. 2. The manufacturing process begins with premanufactured rolls of thermoplastic mesh on upper web unreel 70 and lower web unreel 72. Lower web 74 passes through web tension control 75 and through thermal forming rolls 76, which form the pocket for the pellets, and past cold air gun 77. The pellets are then placed on the lower web through dispensing roll 78. The upper web 79 passes through web tension control 80 and is placed on the lower web (with formed and filled pockets) through upper web application rolls 82. The upper web is then sealed over the pockets with sealing rolls 84 and the joined webs are then trimmed with side length shear rolls 86. The finished product is then sent to be placed in a housing and sent for final packaging using conventional techniques.

### EXAMPLE 1

An embodiment of the invention was prepared using two red polypropylene screens having a strand count per inch of 27.6 by 25.0 with a tensile strength of MD: 42.0 and CD: 34.0. The mesh size of the screen was 0.018 inches. The dimensions of the finished screens were 4.0 inches wide by 11.25 inches long. The joined screens had 13 pockets, each about 0.65 inches high. These pockets were filled with about 8 grams of QuickBayt attractant. QuickBayt attractant is commercially available and is a ready-to-use dry scatter bait containing 0.5% imidacloprid and two insect attractants.

The filled screens were inserted into a yellow laminated cardboard housing that was 4.5 inches wide and 12 inches tall. The housing contained knockout windows to expose the screens during use. This housing was then closed and glued shut to form the final unit.

Two of these final units were then placed in a polyethylene laminated foil pouch with a finished size of 16 inches by 7 inches, and the pouch was placed into a display carton.

The purpose of the above description is to illustrate some embodiments of the present invention without implying a limitation. It will apparent to those skilled in the art that various modifications and variations may be made in the apparatus or procedure of the invention without departing from the scope or spirit of the invention.

What is claimed is:

1. A device for attracting and killing insects comprising:
(a) a first screen, comprising a plurality of openings;
(b) a second screen comprising a plurality of openings and attached to said first screen through a plurality of seams to form a plurality of pockets between said screens;
(c) a plurality of pellets comprising an attractant and a poison for said insects;
(d) a housing to hold said first screen and said second screen; and
(e) an attachment device to permit said device to be placed at least about four feet above the ground.
wherein said openings in said screens are sufficiently large to allow said insects to feed upon said pellets, but not so large as to allow said pellets to fall out of said device.

2. The device of claim 1, wherein said attractant comprises at least one pheromone or food-based attractant.

3. The device of claim 1 or 2, wherein said poison is an insecticide.

4. The device of claim 3, wherein said insecticide is selected from organophosphates, carbamates, chloro-nicotinyls, pyrethrins, and pyrethroids.

5. The device of claim 4, wherein said insecticide is imidacloprid.

6. The device of any one of claims 1 to 5, wherein said housing is comprised of cardboard, kraft paper, or plastic.

7. The device of any one of claims 1 to 6, wherein said housing is from about 2 inches to about 12 inches wide and about 6 inches to about 36 inches in length.

8. The device of any one of claims 1 to 7, wherein said housing is colored to attract insects.

9. The device of claim 8, wherein said housing is colored yellow or red.

10. The device of any one of claims 1 to 9, wherein said first screen and said second screen are colored to attract insects.

11. The device of any one of claims 1 to 10, wherein said first screen and said second screen are colored yellow or red.

12. The device of any one of claims 1 to 11, wherein said first screen and said second screen are less than about 0.5 inches apart.

13. The device of any one of claims 1 to 12, wherein said first screen and said second screen are comprised of polypropylene.

14. The device of any one of claims 1 to 13, wherein said openings have a mesh size of about 0.018 inches.

15. The device of any one of claims 1 to 14, wherein said openings are square or rectangular.

16. The device of any one of claims 1 to 15, wherein said plurality of pellets comprise a first plurality of pellets comprising said attractant, and a second plurality of pellets comprising said poison.

17. The device of claim 16, wherein said attractant comprises at least one pheromone or food-based attractant.

18. The device of claim 16, wherein said poison is an insecticide.

19. The device of claim 18, wherein said insecticide is selected from organophosphates, carbamates, chloro-nicotinyls, pyrethrins, and pyrethroids.

20. The device of claim 19, wherein said insecticide is imidacloprid.

21. A method for controlling flying insects comprising the step of hanging the device of any one of claims 1 to 20 at a height not less than about four feet above the floor level of an area containing undesired flying insects.

22. A method for manufacturing a device for controlling flying insects comprising the steps of:
(a) providing a first screen and a second screen, each having holes of a size small enough to prevent pellets from passing through said holes and said holes being large enough to allow flying insects access to said pellets through said holes;
(b) placing said pellets between said first and said second screen; and
(c) attaching said first screen and said second screen with a plurality of seams to trap said pellets between said first screen and said second screen in a plurality of pockets formed between said seams thereby forming said device.

23. The method of claim 22, further comprising the step of placing said device in a housing.
